(19) United States
(12) Patent Application Publication
(10) Pub. No.: US 2015/0362389 A1
(43) Pub. Date: Dec. 17, 2015

(54) PRESSURE SENSING APPARATUS

(71) Applicant: EZ AS A DRINK PRODUCTIONS, INC., Venice, CA (US)

(72) Inventors: Kostadin Dimitrov Yanev, Alamo, CA (US); Ivo Kostadinov Yanev, Sofia (BG)

(21) Appl. No.: 14/307,251

(22) Filed: Jun. 17, 2014

(51) Int. Cl. G01L 5/16

(52) U.S. Cl. CPC G01L 5/16

(57) ABSTRACT

A pressure sensing apparatus configured to prevent pressure detection for pressures not breaching a threshold. The pressure sensing apparatus may include a first support, a second support, a sensor contact element, a compressible spacer, a pressure sensor, and/or other components. The sensor contact element may be attached to the first support. The pressure sensor may be attached to the second support. The sensor contact element and the pressure sensor may be positioned such that they oppose one another. The compressible spacer may be positioned between the first support and second support. The first support and second support may be spaced at distance substantially equal to a thickness of the compressible spacer. The compressible spacer may encircle the sensor contact element and the pressure sensor.

### FIELD OF THE DISCLOSURE

This disclosure relates to pressure sensors.

### BACKGROUND

Pressure sensors are used in a variety of devices in order to detect physical pressures and/or forces.

### SUMMARY

One or more aspects of the disclosure relates to a pressure sensing apparatus configured to prevent pressure detection for pressures not breaching a threshold. The pressure sensing apparatus may comprise a pressure sensor and a compressible spacer. The pressure sensor may be configured to provide a signal conveying information associated with a physical pressure applied to the pressure sensing apparatus. The signal may be provided responsive to a physical contact with the pressure sensor. In some implementations, physical contact may be facilitated with a sensor contact element included in the pressure sensing apparatus. The sensor contact element may be positioned to oppose the pressure sensor.

The compressible spacer may be configured to prevent the physical contact with the pressure sensor for pressures applied to the pressure sensing apparatus that fail to breach the threshold. The compressible spacer may be configured to allow the physical contact with the pressure sensor for pressures applied to the pressure sensing apparatus that breach the threshold such that only such pressures result in the signal being provided by the pressure sensor.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a pressure sensing apparatus configured to prevent pressure detection for pressures not breaching a threshold, comprising a pressure sensor and a compressible spacer, in accordance with one or more implementations.

FIG. 2 illustrates an exploded view of a pressure sensing apparatus, in accordance with one or more implementations.

FIG. 3 illustrates a top view of the pressure sensing apparatus of FIG. 2 in accordance with one or more implementations.

FIG. 4 illustrates a cross-sectional view of the pressure sensing apparatus of FIG. 2 along line A-A of FIG. 3, in accordance with one or more implementations.

FIG. 5 illustrates a cross-sectional view of the pressure sensing apparatus of FIG. 2 depicting a compression of the compressible spacer facilitating physical contact of the sensor contact element with the pressure sensor.

FIG. 6 illustrates a top view of an implementation of a support used in the pressure sensing apparatus that comprises a cavity for mounting the compressible spacer and a cavity for mounting the pressure sensor, in accordance with one or more implementations.

FIG. 7 illustrates a cross-sectional view of the support of FIG. 6 along line B-B of FIG. 6, in accordance with one or more implementations.

FIG. 8 illustrates a cross-sectional view of the pressure sensing apparatus, in accordance with one or more implementations.

FIG. 9 illustrates a kit of the pressure sensing apparatus, in accordance with one or more implementations.

FIG. 10 illustrates the pressure sensing apparatus being employed in a handheld electronic device, in accordance with one or more implementations.

### DETAILED DESCRIPTION

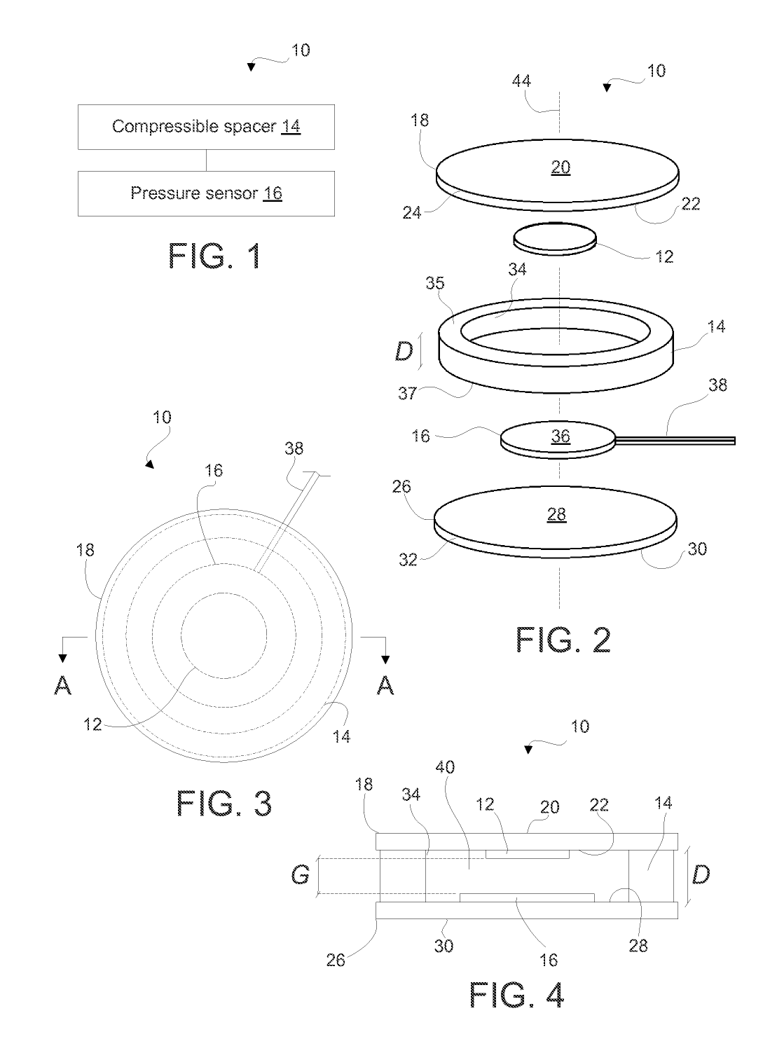

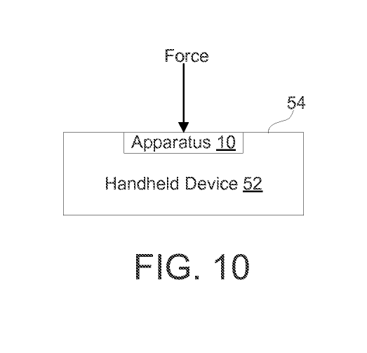

FIG. 1 illustrates a pressure sensing apparatus 10, in accordance with one or more implementations. The pressure sensing apparatus 10 may be configured to prevent pressure detection for pressures not breaching a threshold. In some implementations, the pressure sensing apparatus 10 may be suitable for employment as a pressure sensing component in a handheld device (e.g., device 52 in FIG. 10) configured to measure external pressures exerted on the handheld device. For example, the handheld device may be an exercise device. The exercise device may be configured to detect and/or provide a readout of pressures exerted on the device that breach a threshold pressure, and/or otherwise not provide a detection and/or readout of pressures exerted on the device should the pressures not breach the threshold. However, it is to be noted that those skilled in the art will may appreciate other applications for employment of the pressure sensing apparatus 10 in accordance with one or more implementations presented herein.

In FIG. 1, the pressure sensing apparatus 10 may comprise a compressible spacer 14, a pressure sensor 16, and/or other components. The pressure sensor 16 may be configured to provide a signal conveying information associated with an external physical pressure applied to the pressure sensing apparatus 10. The signal provided by the pressure sensor 16 may be provided in response to a physical contact with the pressure sensor 16. In some implementations, physical contact may be facilitated by compression of the compressible spacer 14 such that the pressure sensor 16 is exposed and/or otherwise made available to receive physical contact. For example, physical contact may be provided by an external contact source (e.g., a user and/or an external structure/surface). In some implementations, physical contact may be facilitated by a sensor contact element disposed and arranged on the pressure sensing apparatus 10. The sensor contact element may be configured to contact the pressure sensor 16 after a predetermined amount of compression of the compressible spacer 14.

The pressure sensor 16 may be an electronic pressure sensor, a mechanical pressure sensor, and/or other type of pressure and/or force sensor. The pressure sensor 16 may employ a diaphragm, piston, bourdon tube, bellows, and/or other components. The pressure sensor 16 may be configured to generate output signals associated with strain, stress, and/or other force metric on the pressure sensor 16 as a function of an applied force over an area of the pressure sensor 16. The pressure sensor 16 may comprise one or more of a piezoresistive strain gauge, a capacitive strain sensor, an electromagnetic sensor, pieszoelectric sensor, an optical strain sensor, and/or other types of pressure and/or force sensors.

The signal conveyed by the pressure sensor 16 may be configured to facilitate a quantification of the pressure and/or force transmitted to and received by the pressure sensor 16. The output signals may be communicated to a computing platform (not shown) configured to determine, from the output signals, the applied force and/or pressure. For example, out signals provided by a strain gauge type pressure sensor may be used to determine the applied force and/or pressure based on the relationship of the measured strain and the applied force. By way of non-limiting illustration, a computing platform may include a desktop computer, a laptop, a smartphone, a cell phone, a handheld electronic device having one or more processors, and/or other type of computing platform.

Pressures applied to the pressure sensing apparatus 10 may be determined based on the quantification of the pressure or force transmitted to the pressure sensor 16 and the threshold. For example, pressures applied to the pressure sensing apparatus 10 may be determined based on a sum of the quantification of the pressure or force transmitted to the pressure sensor 16 and the threshold. By way of non-limiting illustration, a total force of ten pounds applied to the pressure sensing apparatus 10 may be determined based on a summation of a threshold pressure of four pounds and a force of six pounds detected by the pressure sensor 16.

The compressible spacer 14 may be positioned adjacent to the pressure sensor 16. The compressible spacer 14 may be configured to prevent the physical contact with the pressure sensor 16 for pressures applied to the pressure sensing apparatus 10 that fail to breach a threshold. The compressible spacer 14 may be being configured to allow the physical contact with the pressure sensor for pressures applied to the pressure sensing apparatus that breach the threshold such that only such pressures result in the signal being provided by the pressure sensor. For example, if the pressure threshold is twelve pounds and a force of only ten pounds is exerted on the pressure sensing apparatus 10, the pressure sensor 16 may not detect any pressure or force. However, if the pressure threshold is twelve pounds and a force of fourteen pounds is exerted on the pressure sensing apparatus 10, the exerted force may be detected.

In some implementations, the compressible spacer 14 may include an elastomeric material. Such an elastomeric material may be natural or synthetic. Examples of elastomeric materials may include one or more of polyisoprene, polybutadiene, chloropene, butyl rubber, styrene-butadiene, nitrile rubber, polyacrylic rubber, silicone rubber, fluorosilicone, fluoroelastomers, ethylene-vinyl acetate, and/or other elastomeric materials. In some implementations, the compressible spacer 14 may include other materials or compressible objects. For example, in some implementations, the compressible spacer 14 may comprise a spring made from metal and/or other material.

The threshold pressure and/or force may be determined based on the geometry of the compressible spacer 14, the material and material properties (e.g., durometer, elasticity, etc.) of the compressible spacer 14, and/or other feature or parameter of the pressure sensing apparatus 10. For example, the threshold pressure and/or force may be the pressure and/or force required to compress the compressible spacer 14 a predetermined distance.

Those skilled in the art will appreciate that by varying one or more of these parameters and/or other features of the pressure sensing apparatus 10 may facilitate changing and/or tuning the threshold pressure and/or force that must be overcome in order to facilitate physical contact with the pressure sensor 16. One or more aspects and/or features of the pressure sensing apparatus 10 will brought out in more detail in the descriptions and figures provided herein (e.g., FIGS. 2-10).

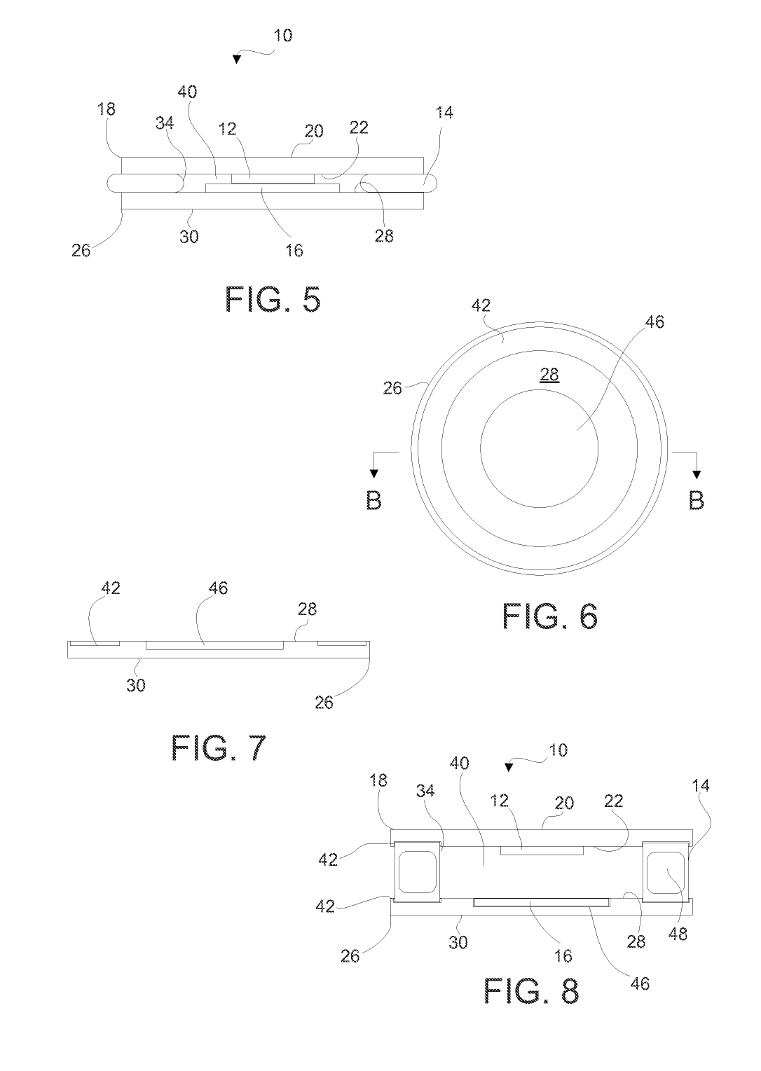

FIG. 2 illustrates an exploded view of the pressure sensing apparatus 10, in accordance with one or more implementations. FIG. 4, FIG. 5, and FIG. 8 depict assembled views of the pressure sensing apparatus 10, in accordance with one or more implementations. The pressure sensing apparatus 10 may comprise a first support 18, sensor contact element 12, compressible spacer 14, pressure sensor 16, a second support 26, and/or other components. The pressure sensing apparatus 10 may have a longitudinal axis shown by imaginary center line 44.

The first support 18 may have a first surface 20 and a second surface 22. The second surface 22 may be opposite the first surface 18. The first support 18 may have a circumferential side edge 24 communicating between the first surface 20 and the second surface 22. The first support 18 may be substantially planar. The first support 18 may be substantially disc shaped. The first support 18 may be a rigid material. The first support 18 may be formed from plastic, metal, wood, and/or other material and/or materials suitable for the intended purpose(s) presented herein. The first support 18 may be disposed and arranged adjacent to a first side 35 of the compressible spacer 14. The first support 18 may coaxially align with the center line 44 of the pressure sensing apparatus 10.

The second support 26 may have a first surface 28 and a second surface 30. The second surface 30 may be opposite the first surface 28. The second support 26 may have a circumferential side edge 32 communicating between the first surface 28 and the second surface 30. The second support 26 may be substantially planar. The second support 8 may be disc shaped. The second support 26 may be a rigid material. The second support 26 may be formed from a plastic, metal, wood, and/or other material and/or materials suitable for the intended purpose(s) presented herein. The second support 26 may be disposed and arranged adjacent to a second side 37 of the compressible spacer 14 that is opposite the first side 35. The second support 26 may coaxially align with the center line 44 of the pressure sensing apparatus 10.

It is to be noted that the shape, dimensions, and/or materials of the first support 18 and second support 26 may be of the designers choice and should not be considered limited by the descriptions and depictions presented herein. For example, the first support 18 and second support 26 may be polygonal (or other shape), curved, convex, concave, and/or have other geometries, shapes, and/or forms.

The sensor contact element 12 may be attached to the first support 18. The sensor contact element 12 may be attached to the second surface 22 of the first support 18. The sensor contact element 12 may have an appreciable thickness as to project a distance from the second surface 22 of the first support 18 that is suitable for the intended purpose(s) presented herein (shown more clearly in the cross sectional views in FIG. 4 and FIG. 5). The sensor contact element 12 may be disposed and arranged as to coaxially align with the center line 44 of the pressure sensing apparatus 10.

The sensor contact element 12 may comprise a rigid body. The sensor contact element 12 may have a shape and/or form that is similar to the first support 18 and/or second support 26 (e.g., disc shaped), and/or other shapes and/or forms. The sensor contact element 12 may be temporarily or permanently attached to the first support 18 using one or more of an adhesive, a mechanical fastener, a hook and loop fastener (e.g., Velcro®), a clip, a weld, and/or other approaches for temporary or permanent couplings. For example the sensor contact element 12 may have an adhesive backing (not shown) to facilitate temporary or permanent attachment.

In some implementations, the attachment of the sensor contact element 12 to the first support 18 may be permanent. In some implementations, the attachment of the sensor contact element 12 to the first support 18 may be removable. In some implementations, the sensor contact element 12 and the first support 18 may be integrated as a single object. For example the sensor contact element 12 may comprise a raised boss that is formed with, and projects from, the first support 18 (e.g., via machining, injection molding, and/or other by other techniques). In some implementations, the sensor contact element 12 may be omitted such that the first support 18 comprises the sensor contact element of the pressure sensing apparatus 10 (e.g., wherein the second surface 22 of the first support 18 may be configured to physically contact the pressure sensor 16).

The pressure sensor 16 may comprise a sensing area 36 and a wire lead 38 extending therefrom. The sensing area 36 may include components configured to generate output signals associated with an applied pressure on the sensor area 36. The wire lead 38 may be configured to communicate the electrical signals provided by the pressure sensor 16 to electronic storage, a computing platform, and/or other external device and/or location.

The pressure sensor 16 may be attached to the second support 26. The pressure sensor 16 may be attached to the first surface 28 of the second support 26. The pressure sensor 16 may be temporarily or permanently attached with the second support 26 using one or more of an adhesive, a mechanical fastener, a clip, a weld, and/or other approaches for temporary or permanent couplings. In some implementations, the pressure sensor 16 and the second support 26 may be integrated as a single object. The pressure sensor 14 may be disposed and arranged on the second support 26 such that the pressure sensor 14 is opposed to the sensor contact element 12. The pressure sensor 14 may coaxially align with the center line 44 of the pressure sensing apparatus 10.

In some implementations, the pressure sensor 16 may protrude from the first surface 28 of the second support 26 (e.g., as shown in FIG. 4). In some implementations, the pressure sensor 16 may be flush with the first surface 28 of the second support 26. In some implementations, the pressure sensor 16 may be recessed into the second support 26. For example, the pressure sensor 16 may be mounted in a cavity (second cavity 46 in FIGS. 6-8) formed into the first surface 28 of the second support 26. The cavity may be configured to mount the pressure sensor 16 such that the pressure sensor 16 is substantially flush with the first surface 28 and/or recessed a distance within the second support 26. In some implementations, an additional cavity (not shown) may be provided for the wire lead 38 of the pressure sensor 16.

The compressible spacer 14 may have an annular shape. For example, the compressible spacer 14 may be a ring or ring shaped (e.g., such as an O-ring). The compressible spacer 14 may have a cross-section that is circular, polygonal, and/or other shape. The compressible spacer 14 may have a thickness, “D”. The compressible spacer 14 may encircle the pressure sensor 16 and/or sensor contact element 12 (e.g., shown more clearly in FIG. 3). The compressible spacer 14 may coaxially align with the center line 44 of the pressure sensing apparatus 10. The compressible spacer 14 may comprise a central aperture 34 communicating therethrough. For example, the aperture 34 may communicate through the compressible spacer 14 from the first side 35 to the second side 37. The aperture 34 may coaxially align with the longitudinal axis of the compressible spacer 14 (e.g., center line 44 of the pressure sensing apparatus 10). In other implementations, the compressible spacer 14 may be of a different shape, a different size, a different geometry, and/or otherwise have a different physical configuration.

The compressible spacer 14 may be positioned between the first support 18 and the second support 26. The first support 18 and second support 26 may be spaced apart at least a distance that is substantially equal to the thickness “D” of the compressible spacer 14 (shown more clearly in FIG. 4). As shown in FIG. 4, a passage 40 may be formed within the pressure sensing apparatus 10. The passage 40 may include the space within the aperture 34 of the compressible spacer 14. For example the passage 40 may be defined by sidewalls of the aperture 34, and portions of the second surface 22 of the first support 18 and the first surface 28 of the second support 26 that are encircled by the aperture 34 of the compressible spacer 14. As such, the passage 40 may communicate between the first support 18 and the second support 26. The pressure sensor 16 and the sensor contact element 12 may be positioned within the passage 40.

A distance between the sensor contact element 12 and the pressure sensor 16 may define a gap, “G”. The threshold pressure and/or force on pressure sensing apparatus 10 that is required to be breached to facilitate contact of the sensor contact element 12 with the pressure sensor 16 may be the pressure or force required to compress the compressible spacer 14 a distance that is equal to the distance of the gap. Thus, this threshold may be predetermined based on one or more of the distance of gap “G”, the surface area of the surfaces of first support 18 and/or second support 26, the material, and/or material properties of compressible spacer 14, the geometry of compressible spacer 14, and/or one or more other variables.

In FIG. 5, a compression of the compressible spacer 14 is shown. Compression may be facilitated based on pressures applied to the first support 18 and/or second support 26 (e.g., force applied on the first support 18 in the direction towards the second support 26 and/or on the second support 26 in the direction toward the first support 18) that breach the threshold. The application of such forces and/or pressures may facilitate physical contact of the sensor contact element 12 with the pressure sensor 16 as shown such that output signals are provided by the pressure sensor 16. Again, the signal conveyed by the pressure sensor 16 may be configured to facilitate a quantification of the pressure or force transmitted to the pressure sensor 16. Pressures applied to the pressure sensing apparatus 10 may be determined based on the quantification of the pressure or force transmitted to and received by the pressure sensor 16 and the threshold, such as the sum of the quantification of the pressure or force received by the pressure sensor 16 and the threshold.

FIG. 6 and FIG. 7 show views of the second support 26 (or alternatively the first support 18), in accordance with one or more implementations. FIG. 6 depicts a view showing the first surface 28 of the second support 26. The second support 26 may include a first cavity 42. The first cavity 42 may be formed into the first surface 28 of the second support 26. The first cavity 42 may comprise an annular cavity configured to mount the compressible spacer 14 in its positioning between the first support 18 and second support 26 (e.g., shown in FIG. 8). In some implementations, the first cavity 42 may be configured to mount the compressible spacer 14 through friction. For example, the first cavity 42 may have a width that is slightly less than the width of the annular body of the compressible spacer 14 such that the compressible spacer 14 is essentially “gripped” by the sidewalls of the first cavity 42.

The depth of the first cavity 42 may be a small fraction of the thickness “D” of the compressible spacer 14 such that when the pressure sensing apparatus 10 is assembled (as shown in FIG. 8) the spacing of the first support 18 and the second support 26 is substantially equal to the thickness of the compressible spacer 14. It is noted that the first cavity 42 may additionally be formed into the second surface 22 of the first support 12 as shown in FIG. 8 to facilitate a mounting of the compressible spacer 14 to the first support 18 as well.

Returning to FIG. 6, the second support 26 may include a second cavity 46 formed therein and recessed relative the first surface 28. The second cavity may 26 be configured and arranged to mount the pressure sensor 16 thereon. In some implementations, the second cavity 26 may have a depth that is configured to recess the pressure sensor 16 into the second support 26 such that the pressure sensor 16 is flush with the first surface 28 (as shown in FIG. 8). In some implementations, the second cavity 26 may have a depth that is configured to recess the pressure sensor 16 into the second support 26 such that the pressure sensor 16 protrudes somewhat from the first surface 28 (as shown in FIG. 8).

It is noted that the shape and/or configuration of the first cavity 42 and/or second cavity 46 may be different depending on the shape and/or configuration of the compressible spacer 14 and/or pressure sensor 16, respectively, and is anticipated.

FIG. 8 depicts a cross-sectional view of the pressure sensing apparatus 10, according to one or more implementations. The current depiction of the pressure sensing apparatus 10 shows the compressible spacer 14 formed to have an interior annular passage 48 communicating through the body of the compressible spacer 14. The passage 48 may provide a type of fluid bladder of the compressible spacer 14. The compressibility of the compressible spacer 14 and the threshold pressure required to facilitate contact with the pressure sensor 16 may be adjusted and/or tuned based on the size and/or shape of the passage 48, a type or pressure of a fluid (e.g., air, water, oil, and/or other fluids) filled within passage 48, and/or other approaches for adjusting and/or tuning the threshold pressure. In some implementations, an air filled passage 48 may facilitate weight reduction of the pressure sensing apparatus 10.

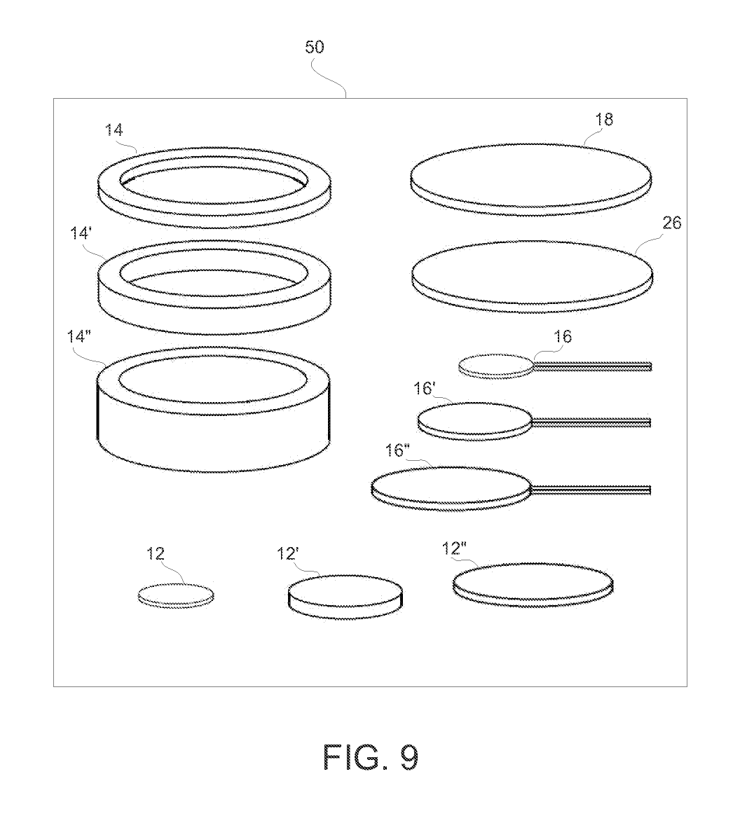

FIG. 9 shows an implementation of a kit 50 of the pressure sensing apparatus 10, in accordance with one or more implementations. The kit 50 may comprise one or more of: the first support 18, the second support 26, multiple implementations of the sensor contact element 12, 12′, and 12″, multiple implementations of the compressible spacer 14, 14′, and 14″, multiple implementations of the pressure sensor 16, 16′, and 6″, and/or other components. The implementations of the sensor contact element 12, 12′, and 12″ may include each be of different materials and/or geometries (e.g., size, shape, diameter, thickness, etc.). The implementations of the compressible spacer 14 may include different materials and/or geometries (e.g., size, shape, diameter, thickness, etc.). The implementations of the pressure sensor 16, 16′, and 16″ may each be of different sizes (e.g., sensing area sizes), material, and/or sensor types.

In an implementation of the kit 50, the pressure sensing apparatus 10 may employ removable attachment techniques for each of the sensor contact element 12, 12′, 12″, compressible spacer 14, 14′, 14″, and pressure sensor 16, 16′, 16″. For example, through use of removable adhesives and/or other removable attachment techniques, a user of the kit 50 may be able to selectively assembly the pressure sensing apparatus 10 to correspond to a specified threshold, and/or other specifications. In some implementations, the kit 50 may be accompanied by a reference chart (not shown) which may illustrate to a user what threshold pressure the pressure sensing apparatus 10 may correspond to depending on the selection of components from the kit 50. The kit 50 may contain more or less components than shown, and may include other components (e.g., a removable adhesive).

FIG. 10 illustrates an implementation of the pressure sensing apparatus 10 used with a handheld electronic device 52. The handheld electronic device 52 may include one or more physical processors configured by computer-readable instructions to determine pressures applied to the device 52 through the use of the pressure sensing apparatus 10. For example, the pressure sensing apparatus 10 may be employed with one or more surfaces 54 of the handheld device 52. The pressure sensing apparatus 10 may be configured to detect pressures and/or forces that are applied to the surface 54 that breach a threshold. In some implementations, the handheld electronic device 52 may be configured to receive a signal from the pressure sensor 16 included in the pressure sensing apparatus 10 to determine, from the signal, the applied force and/or pressure on the device 52.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A pressure sensing apparatus configured to prevent pressure detection for pressures not breaching a threshold, the apparatus comprising:
a pressure sensor configured to provide a signal conveying information associated with a physical pressure applied to the pressure sensing apparatus, the signal being provided responsive to a physical contact with the pressure sensor; and
a compressible spacer configured to prevent the physical contact with the pressure sensor for pressures applied to the pressure sensing apparatus that fail to breach a threshold, the compressible spacer being configured to allow the physical contact with the pressure sensor for pressures applied to the pressure sensing apparatus that breach the threshold such that only such pressures result in the signal being provided by the pressure sensor.

2. The apparatus of claim 1, wherein the signal conveyed by the pressure sensor is configured to facilitate a quantification of a pressure or force received by the pressure sensor.

3. The apparatus of claim 2, wherein pressures applied to the pressure sensing apparatus are determined based on the quantification of the pressure or force received by the pressure sensor and the threshold.

4. The apparatus of claim 3, wherein pressures applied to the pressure sensing apparatus are determined based on a sum of the quantification of the pressure or force received by the pressure sensor and the threshold.

5. The apparatus of claim 1, wherein the compressible spacer includes an elastomeric material.

6. The apparatus of claim 1, wherein the compressible spacer has an annular shape and encircles the pressure sensor.

7. The apparatus of claim 1, comprising:
a first support;
a second support; and
a sensor contact element, the sensor contact element being attached to the first support;
wherein the compressible spacer is positioned between the first support and the second support such that the first support and second support are spaced apart at least a distance that is substantially equal to a thickness of the compressible spacer;
wherein the pressure sensor is attached to the second support, and wherein the pressure sensor opposes the sensor contact element;
wherein a compression of the compressible spacer based on pressures applied to the first support or second support that breach the threshold facilitates physical contact of the sensor contact element with the pressure sensor.

8. The apparatus of claim 7, wherein the compressible spacer includes a central aperture defining a passage communicating between the first support and the second support, and wherein the pressure sensor and sensor contact element are positioned within the passage.

9. The apparatus of claim 7, wherein a distance between the sensor contact element and the pressure sensor defines a gap, wherein the threshold is a pressure or force required to compress the compressible spacer a distance that is equal to the distance of the gap.

10. The apparatus of claim 7, wherein the first support, second support, sensor contact element, pressure sensor, and compressible spacer are coaxially aligned.

11. The apparatus of claim 7, wherein the first support and second support are disc shaped.

12. The apparatus of claim 7, wherein the first support and second support include cavities for mounting the compressible spacer in its position between the first support and second support.

13. The apparatus of claim 7, wherein the second support includes a cavity for mounting the pressure sensor to the second support.

14. The apparatus of claim 7, wherein the pressure sensor is recessed within the second support.

15. The apparatus of claim 7, wherein the attachment of the pressure sensor to the second support is removable.

16. The apparatus of claim 7, wherein the attachment of the attachment of the sensor contact element to the first support is removable.

17. The apparatus of claim 7, wherein the first support and second support are attached to opposite sides of the compressible spacer.

18. The apparatus of claim 1 wherein the compressible spacer includes a fluid filled bladder.

19. The apparatus of claim 1, wherein the pressure sensor is configured to provide a signal conveying information associated with a physical pressure applied to a handheld device employing the apparatus.

20. A pressure sensing apparatus kit, the pressure sensing apparatus configured to prevent pressure detection for pressures not breaching a threshold, the kit comprising:
a first support;
a second support;
one or more sensor contact elements, the one or more sensor contact elements being configured for attachment to the first support;
one or more pressure sensors, the one or more pressure sensor being configured to provide a signal conveying information associated with a physical pressure applied to the pressure sensing apparatus, the signal being provided responsive to a physical contact with an individual one of the one or more pressure sensors, the one or more pressure sensors being configured for attachment to the second support; and
one or more compressible spacers, the one or more compressible spacers being configured to prevent the physical contact with an individual one of the one or more pressure sensors for pressures applied to the pressure sensing apparatus that fail to breach a threshold, the one or more compressible spacers being configured to allow the physical contact with an individual one of the one or more pressure sensors for pressures applied to the pressure sensing apparatus that breach the threshold such that only such pressures result in the signal being provided by the individual one of the one or more pressure sensors, and the one or more compressible spacers being configured for positioning between the first support and the second support such that the first support and second support are spaced apart at least a distance that is substantially equal to a thickness of an individual one of the one or more compressible spacers.
